(19) United States
(12) Patent Application Publication
(10) Pub. No.: US 2010/0219545 A1
(43) Pub. Date: Sep. 2, 2010

(54) APPARATUS AND METHOD OF MANUFACTURING ASEPTIC CAPSULES

(75) Inventor: Jung Keug Park, Seoul (KR)

Correspondence Address: SUGHRUE MION, PLLC, 2100 PENNSYLVANIA AVENUE, N.W., SUITE 800, WASHINGTON, DC, 20037, US

(73) Assignees: Jung Keug PARK, Seoul (KR); Sung Koo KIM, Busan (KR); Suk Koo LEE, Seoul (KR); LIFECORD INC., Seoul (KR)

(21) Appl. No.: 12/681,566

(22) PCT Filed: Oct. 1, 2008
(86) PCT No.: PCT/KR08/05796

§ 371 Date: Apr. 2, 2010

(30) Foreign Application Priority Data
Oct. 5, 2007 (KR) 10-2007-0100323

(51) Int. Cl. B29B 9/12

(52) U.S. Cl. 264/13; 425/10

(57) ABSTRACT

Provided are an apparatus and a method of aseptically manufacturing cell-immobilizing capsules, the apparatus comprising a multi-nozzle assembly and a double mesh system for the washing and size-selection of the capsules, and thus, the production, washing, selection and recovery of the capsules can be easily conducted under an aseptic condition in an integrated fashion.

### FIELD OF THE INVENTION

The present invention relates to an apparatus and a method of aseptically manufacturing cell-immobilizing capsules.

### DESCRIPTION OF THE PRIOR ART

Cell immobilization is a technique of immobilizing cells in a material that provides a 3-dimensional environment for the growth and isolation of the cells, and it is used to produce active materials from cells, including antibiotics, vaccines and monoclonal antibodies, and therefore, it is widely used in artificial organ applications for treating diabetes, hepatic failure, Parkinson's disease, Alzheimer's disease, etc. (see Willem M., et al., Cell Encapsulation Technology and Therapeutics, 14-15 (1999)).

Polymers generally used for cell immobilization include synthetic and natural polymers such as alginate, chitosan, polyvinyl alcohol, collagen, carboxymethyl cellulose, agarose, and gelatin (see Lambert, F., et al., Bio. Chem. Biophys. Acta., 759: 81-88 (1983)). Based on the characteristics of such polymers, various immobilization methods have been developed (see Birnbaum, S., et al., FEBS Letters, 122: 393-404 (1981); and Brodelius, P., et al., FEBS Letters, 122: 312-319 (1980)). When alginate which has good biocompatibility (see Higasi, T. et al., Biosci. and Bioeng., 97 (2004)) is used, it becomes possible to control the molecular weight cut-off (MWCO) to provide an immune barrier (see Bunger, G., et al., Biomaterials., 26: 2353-2360 (2005)). Therefore, alginate can be readily used for clinical applications (see Orive, G. et al., Nat Med., 9: 104-7 (2003)).

In a typical cell immobilization method using alginate, an alginate suspension of cells in a cross-linking divalent cation solution, such as CaCl₂ or BaCl₂, is shaped in the form of droplets to be converted into capsules (see D. Serp., et al., Biotechnology and Bioengineering, 70(1): 41-53 (2000)). In order to produce such capsules of a desired size, there have been various commercially available encapsulation apparatuses (e.g., Inotech Encapsulation Product (INOTECH Biotechnologies), Encapsulation/Immobilization Systems (Nisco Engineering AG)) based on vibration, centrifugal force, static electricity or air jet (see Willem M., et al., Cell Encapsulation Technology and Therapeutics, 14-15 (1999)).

However, capsules produced by vibration, centrifugal force, static electricity or air jet tend to have an undesirable size distribution. Excessively large capsules may prevent sufficient oxygen supply to cells within the capsules to cause hypoxia, resulting in necrosis, while excessively small capsules are susceptible to breakage when a physical force such as shearing stress is applied. Accordingly, the above-described methods require a separate step for selecting capsules having the desired size. In addition, the selected capsules thus produced must be washed in separate containers under an aseptic environment, which makes such methods complicated and uneconomical (see Korean Patent No. 725730; and D. Serp., et al., Biotechnology and Bioengineering, 70(1): 41-53 (2000)).

Therefore, there has been a need to develop an improved apparatus for manufacturing cell-immobilizing capsules of a desired size without the risk of microorganism contamination.

### SUMMARY OF THE INVENTION

Accordingly, it is an object of the present invention to provide an apparatus for manufacturing capsules, which can be efficiently used to conduct the production, washing and selection of desired capsules under an aseptic condition.

It is another object of the present invention to provide a method of manufacturing aseptic capsules using the apparatus.

In accordance with an aspect of the present invention, there is provided an apparatus for manufacturing aseptic capsules, which comprises: a vessel equipped with a compressed air inlet, a washing medium inlet/outlet, and a product recovery line, which contains a crosslinking solution kept under an aseptic condition; a multi-nozzle assembly installed in the upper part of the vessel for extruding a cell suspension to form droplets that fall into the crosslinking solution to form capsules; an outer mesh removably installed inside the lower part of the vessel; and an inner mesh removably installed inside the outer mesh, wherein the combination of the outer and inner meshes functions to allow the selection of capsules having a predetermined size distribution range.

In accordance with another aspect of the present invention, there is provided a method of manufacturing aseptic capsules using the above-described apparatus, which comprises: extruding a cell suspension to form droplets using the multi-nozzle assembly; hardening the droplets to form capsules using the crosslinking solution; and washing the capsules using the washing medium and selecting predetermined-sized capsules using the inner mesh and the outer mesh.

### BRIEF DESCRIPTION OF THE DRAWINGS

The above and other objects and features of the present invention will become apparent from the following description of the invention taken in conjunction with the accompanying drawings, which respectively show:

FIG. 1: a schematic diagram illustrating an apparatus for manufacturing aseptic capsules according to an embodiment of the present invention;

FIG. 2: a schematic diagram illustrating a crosslinking solution-containing vessel in an aseptic capsule-manufacturing apparatus according to an embodiment of the present invention;

FIG. 3: a schematic view illustrating a capsule selection process using two meshes each having a plurality of pores of a predetermined size, which are installed in a crosslinking solution-containing vessel of an aseptic capsule-manufacturing apparatus according to an embodiment of the present invention; and

FIG. 4: an enlarged view of a capsule produced by an aseptic capsule-manufacturing apparatus according to an embodiment of the present invention.

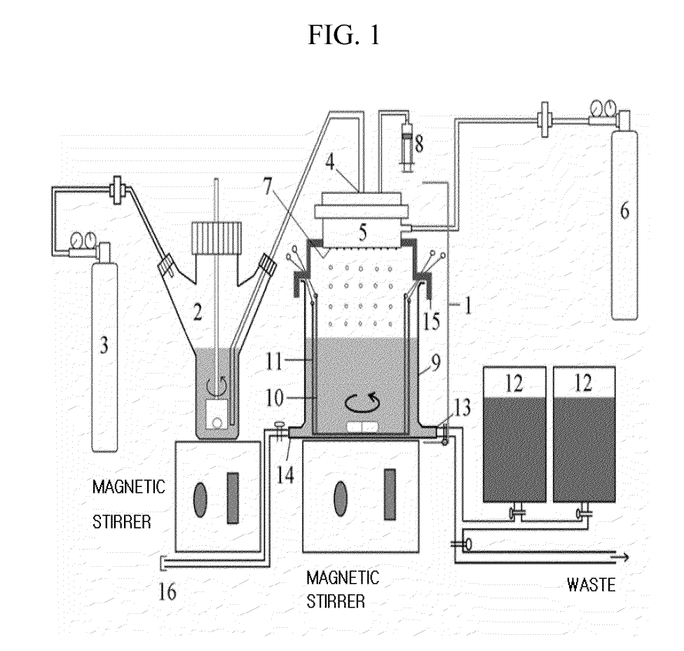

<Brief description of the reference numerals in FIG. 1>

| | |
|---|---|
| 1: capsule-manufacturing | |
| apparatus of the present | |
| invention | |
| 2: cell suspension supply vessel | 3: compressed air supply |
| 4: cell suspension inlet port | 5: multi-nozzle assembly |
| 6: compressed air supply | 7: extrusion nozzles |
| 8: air pressure controller | 9: crosslinking solution-containing |
| | vessel |
| 10: inner mesh | 11: outer mesh |
| 12: washing medium | 13: washing medium inlet/outlet port |
| 14: capsule transport port | 15: multi-nozzle adaptor |

### DETAILED DESCRIPTION OF THE INVENTION

Hereinafter, an embodiment of an apparatus for manufacturing aseptic capsules according to the present invention will be described in detail with reference to the accompanying drawings.

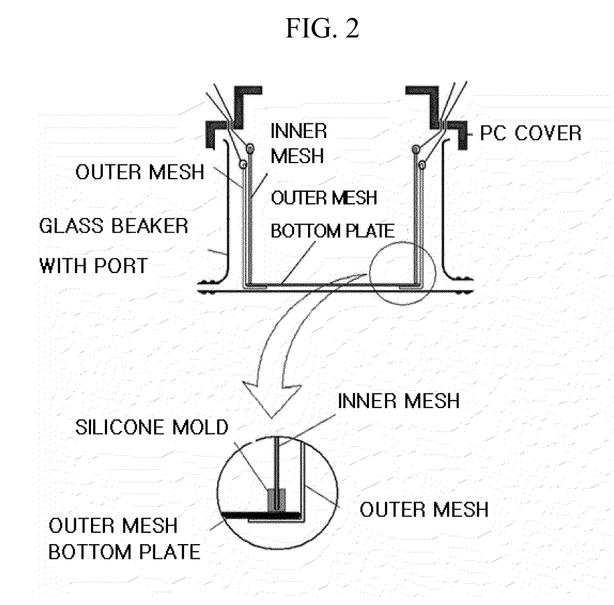

FIG. 1 illustrates an integrated apparatus 1 for manufacturing aseptic capsules according to an embodiment of the present invention (hereinafter, referred to as simply “capsule-manufacturing apparatus 1”), and FIG. 2 illustrates a crosslinking solution-containing vessel 9 of the capsule-manufacturing apparatus 1.

Referring to FIGS. 1 and 2, a cell suspension containing animal cells to be immobilized is introduced into a cell suspension supply vessel 2, compressed using compressed air from a compressed air supply 3 and then introduced to a multi-nozzle assembly 5 of the capsule-manufacturing apparatus 1 via a cell suspension inlet port 4. The cell suspension is forced through the multi-nozzle assembly 5 while compressed air from a compressed air supply 6 is introduced to the multi-nozzle assembly 5 in such a way that droplets having a desired size distribution are ejected from the multi-nozzle assembly 5 to be quenched in the crosslinking solution of the crosslinking solution-containing vessel 9.

The cell suspension supply vessel 2 may be maintained at a low temperature so as to prevent cell damage, and it may be equipped with an agitator (e.g., a magnetic stirrer) to uniformly distribute the animal cells in the cell suspension. The compressed air from the compressed air supply 3 is sterilized by passing through a filter (not shown) and it may be maintained at a pressure ranging from 0.02 to 0.3 MPa. The multi-nozzle assembly 5 may be made of stainless steel or polycarbonate, and it comprises a plurality of extrusion nozzles 7, e.g., 1 to 150 extrusion nozzles, which may be made of injection needles having a diameter of 18 to 24 G, preferably 23 G. The end of each needle may protrude downward from the bottom surface of the multi-nozzle assembly 5 by a length of 0.3 to 1.0 mm, preferably 0.7 mm, and the lateral side of each needle may have air-emitting holes (not shown) having a diameter of 1.5 to 3 mm, preferably 1.5 mm.

The droplets ejected from the extrusion nozzles 7 may have an average diameter of 0.3 to 2.0 mm. The size of the droplets can be controlled by adjusting the pressure of the compressed air from the compressed air supply 6 and the setting of the air pressure controller 8 which is positioned above the multi-nozzle assembly 5.

The droplets ejected from the extrusion nozzles 7 fall into the crosslinking solution-containing vessel 9 wherein the crosslinking solution is maintained at 4° C., to be hardened into capsules. The crosslinking solution may be an aqueous CaC₂ or BaCl₂ solution or an aqueous solution containing a multivalent cation (e.g., Ti²⁺ and Al²⁺) or a polymer cation (e.g., chitosan, polyamino acid, polyethylenimine and polyacrylamide). The resultant capsules are subjected to several wash cycles using a washing medium 12 supplied via a washing medium inlet/outlet port 13. The washing medium may be an RPMI (Roswell Park Memorial Institute) medium, a Williams' E medium, and DMEM (Dulbecco's Modified Eagle's Medium), etc. During the washing, undesired small capsules pass through inner and outer meshes 10 and 11 to be removed through the washing medium inlet/outlet port 13, while capsules having a particle size larger than the lower limit of the desired particle size range remain within the inner mesh 10. Then, the removably installed inner mesh 10 is lifted to allow the retained capsules to fall into the outer mesh 11. Then, the capsules of a desired size range are allowed to pass through the outer mesh 11 after lifting the removably installed outer mesh 11, while capsules larger than the desired size remain in the outer mesh 11. The selected capsules accumulated at the bottom part of the crosslinking solution-containing vessel 9 are transported through a capsule transport port 14 into another container (not shown).

The capsule-manufacturing apparatus 1 may further comprise a multi-nozzle adapter 15 made of polycarbonate so that the droplets ejected from the extrusion nozzles 7 fall into a suitable position of the crosslinking solution. The extrusion nozzles 7 may be positioned above the surface of the crosslinking solution at a distance of 120 to 160 mm, preferably about 140 mm.

The crosslinking solution-containing vessel 9 may be of a cylindrical structure having a diameter of 150 to 350 mm, preferably about 225 mm, and a height of 120 to 220 mm, preferably about 170 mm. The crosslinking solution-containing vessel 9 has an air-emitting outlet (5 mm diameter) on the top part in the proximity of the multi-nozzle adapter 15, in order to discharge the air introduced into the crosslinking solution-containing vessel 9 through the multi-nozzle assembly 5 and to maintain a constant positive pressure and an aseptic environment in the crosslinking solution-containing vessel 9.

In the crosslinking solution-containing vessel 9, capsules of a desired size range are selected by manipulating the inner mesh 10 and the outer mesh 11. The inner mesh 10, which may be a cylindrical shape, is open at its bottom and has pores whose diameter corresponds to the lower limit of the desired capsule diameter range. The outer mesh 11, which may be of a bucket shape, has its bottom closed and has pores whose diameter corresponds to the upper limit of the desired capsule diameter range. The pore sizes of the inner mesh 10 and the outer mesh 11 may be 300 to 2,000 μm and 300 to 2,000 μm, respectively. The lower edge part of the inner mesh 10 is removably sealed to the bottom of the outer mesh 11 using a sealing member, e.g., a silicone mold, and this seal is broken only after the washing cycles to remove undesirable small capsules are over.

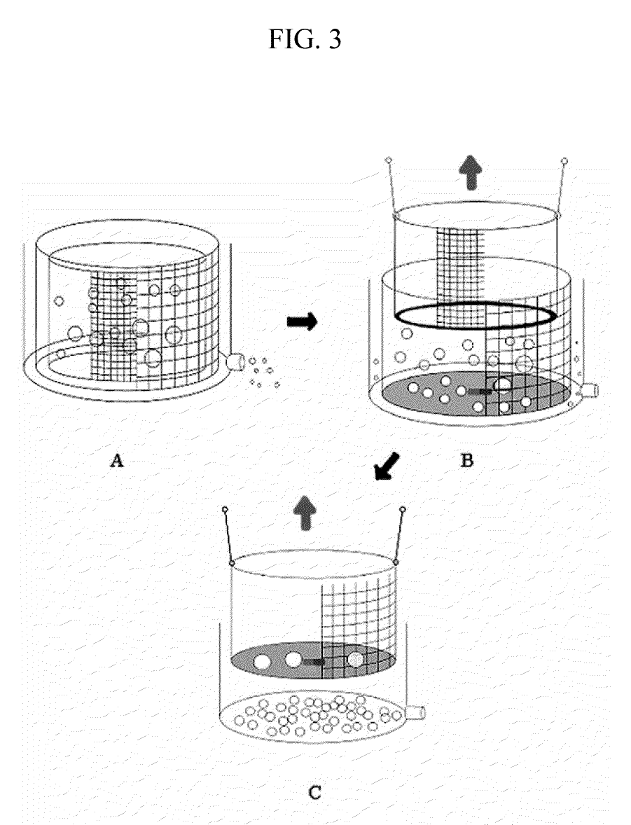

The process of selecting the size of desired capsules using the inner mesh 10 and the outer mesh 11 is as follows. Referring to FIG. 3, together with FIGS. 1 and 2, first, the bottom part of the inner mesh 10 is removably sealed on the bottom of the outer mesh 11 so that the inner mesh 10 and the outer mesh 11 form a combined double mesh structure, and when the capsules accumulated inside the inner mesh 10 is washed, capsules smaller than the lower limit of the desired capsule size range pass through the inner mesh 10 and the outer mesh 11 to be discharged with the washing medium 12. Subsequently, when the inner mesh 10 and the outer mesh 11 are sequentially lifted, capsules larger than the upper limit of a desired capsule size range remain in the outer mesh 11 having a closed bottom. As a result, only capsules having the desired size range are left in the crosslinking solution-containing vessel 9. For example, in order to obtain capsules having a diameter range from 500 to 1,000 mm, the inner mesh 10 and the outer mesh 11 may have pore sizes of 500 mm and 1,000 mm, respectively.

The capsules thus selected are transported into a predetermined system via the capsule transport port 14 disposed at the lower end of the crosslinking solution-containing vessel 9.

The present invention also provides a method of manufacturing aseptic capsules using a capsule-manufacturing apparatus as described above, which comprises: extruding a cell suspension to form droplets using a multi-nozzle assembly; hardening the droplets to form capsules using a crosslinking solution; and washing the capsules using a washing medium and selecting capsules having a desired size using an inner mesh and an outer mesh. Unless specified otherwise, the above description about the capsule-manufacturing apparatus of the present invention is applied.

The extrusion and hardening of the droplets and the washing and size-selection of the capsules may be conducted under a cold condition of 4 to 15° C. so as to prevent cell damage due to the depletion of oxygen and nutrients. The extrusion and hardening of the droplets may be conducted for 5 to 20 minutes and 5 to 10 minutes, respectively, and the washing and size-selection of the capsules may be conducted for 10 to 30 minutes.

In the droplet extrusion step, the cell suspension introduced into the multi-nozzle assembly may comprise a polymer conventionally used for immobilizing cells, e.g., at least one selected from the group consisting of alginate, hydroxypropyl cellulose, hydroxypropyl methyl cellulose, sodium carboxymethyl cellulose, carbomers, hyluronic acid, methyl cellulose, karaya gum, water-soluble starch, pectin, gelatin, polyvinyl alcohol, and polyvinyl pyrrolidone, but is not limited thereto. The droplet extrusion may be conducted using a conventional nozzle operated by vibration or static electricity, in addition to air jet. Preferably, air jet may be conducted under a pressure of 0.02 to 0.3 MPa.

The hardening of the droplets into the capsules may be conducted by stirring the droplets in an aqueous CaCl₂ or BaCl₂ solution or an aqueous solution containing a multivalent cation (e.g., Ti²⁺ and Al²⁺) or a polymer cation (e.g., chitosan, polyamino acid, polyethylenimine and polyacrylamide).

As described above, the apparatus for manufacturing aseptic capsules according to the present invention comprises a multi-nozzle assembly for mass production of capsules and two meshes having predetermined pore sizes for the washing and selection of the capsules, and thus, the washing, selection and recovery of the capsules can be conducted integratedly under an aseptic condition. The capsules thus obtained can be effectively used in cell immobilization and artificial organ applications for treating diabetes, hepatic failure, Parkinson's disease, Alzheimer's disease, etc.

The present invention will be described in further detail with reference to Example. However, it should be understood that the present invention is not restricted by the specific Example.

### Example

### Preparation of Aseptic Capsules

The preparation of alginate capsules was performed for about 10 minutes as follows using a capsule-manufacturing apparatus as illustrated in FIG. 1, which comprises a multi-nozzle assembly having 61 extrusion nozzles and a crosslinking solution-containing vessel in which an inner mesh having 500 μm-sized pores and an outer mesh having 1500 μm-sized pores were installed.

First, about 600 ml of an alginate suspension was introduced into the capsule-manufacturing apparatus and extruded through the multi-nozzle assembly using compressed air to form droplets.

The droplets were dropped into an aqueous 100 mM CaCl₂ solution (4° C.) used as a crosslinking solution and stirred for 5 minutes to be hardened into capsules. The aqueous CaCl₂ solution was discharged via the washing medium inlet/outlet port located at the lower end of the crosslinking solution-containing vessel and the capsules were then washed with 2 l of cold RPMI medium (Sigma-Aldrich, USA) (×4) and then 2 l of Williams' E medium (Sigma-Aldrich, USA) (×2). During the washing, capsules having a size smaller than the pore size of the inner mesh were discharged together with the washing media via the washing medium inlet/outlet port. Then, the metal line connected to the inner mesh was lifted upward by about 7 cm and fixed, and then the mixture was stirred so that capsules having a size larger than the pore size of the outer mesh accumulated inside the outer mesh. Subsequently, the outer mesh was lifted up to remove the capsules larger than the pore size of the outer mesh, and the residual capsules were then transported into a predetermined system via a capsule transport port located at the lower end of the crosslinking solution-containing vessel.

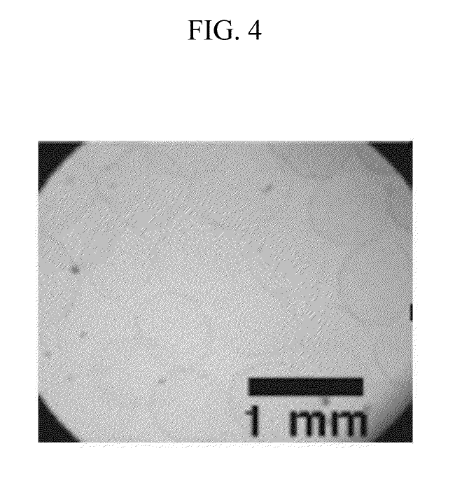

The diameters of the capsules thus obtained were measured. As a result, the capsules had an average diameter of 700 to 1,200 μm. The enlarged view of the capsule is shown in FIG. 4.

While the invention has been described with respect to the specific embodiments, it should be recognized that various modifications and changes may be made by those skilled in the art to the invention which also fall within the scope of the invention as defined as the appended claims.

What is claimed is:

1. An apparatus for manufacturing aseptic capsules, which comprises:
a vessel equipped with a compressed air inlet, a washing medium inlet/outlet, and a product recovery line, which contains a crosslinking solution kept under an aseptic condition;
a multi-nozzle assembly installed in the upper part of the vessel for extruding a cell suspension to form droplets that fall into the crosslinking solution to form capsules;
an outer mesh removably installed inside the lower part of the vessel; and
an inner mesh removably installed inside the outer mesh,
wherein the combination of the outer and inner meshes functions to allow the selection of capsules having a predetermined size distribution range.

2. The apparatus of claim 1, wherein the multi-nozzle assembly comprises 1 to 150 extrusion nozzles.

3. The apparatus of claim 2, wherein the extrusion nozzles are made of injection needles having a diameter of 18 to 24 G.

4. The apparatus of claim 3, wherein each of the needles protrudes downward below the multi-nozzle assembly by a length of 0.3 to 1 mm, and air-emitting holes having a diameter of 1.5 to 3 mm are disposed on the side of the needle.

5. The apparatus of claim 1, wherein the inner mesh has pores whose diameter corresponds to the lower limit of the predetermined capsule diameter range, and the outer mesh has pores whose diameter corresponds to the upper limit of the predetermined capsule diameter range.

6. The apparatus of claim 1, wherein the bottom of the inner mesh is open and the bottom of the outer mesh is closed.

7. The apparatus of claim 1, wherein the crosslinking solution is selected from the group consisting of an aqueous CaCl₂ solution, an aqueous BaCl₂ solution, an aqueous solution containing a multivalent cation, and an aqueous solution containing a polymer cation.

8. A method of manufacturing aseptic capsules using the apparatus of claim 1, which comprises:
extruding a cell suspension to form droplets using the multi-nozzle assembly;
hardening the droplets to form capsules using the crosslinking solution; and
washing the capsules using the washing medium and selecting predetermined-sized capsules using the inner mesh and the outer mesh.

9. The method of claim 8, wherein the extrusion and hardening of the droplets and the washing and size-selection of the capsules are performed in a cold condition of 4 to 15° C.

10. The method of claim 8, wherein the extrusion of the droplets is conducted using air jet, vibration or static electricity.

11. The method of claim 8, wherein the extrusion of the droplets is conducted by injecting air having a pressure of 0.02 to 0.3 MPa.

12. The method of claim 8, wherein the crosslinking solution is selected from the group consisting of an aqueous CaCl₂ solution, an aqueous BaCl₂ solution, an aqueous solution containing a multivalent cation, and an aqueous solution containing a polymer cation.
